(19) United States
(12) Patent Application Publication
(10) Pub. No.: US 2016/0267241 A1
(43) Pub. Date: Sep. 15, 2016

(54) SYSTEM AND METHOD FOR PROVIDING RESTORATIVE CARE

(71) Applicant: Anthony J. Bacchi, West Hurley, NY (US)

(72) Inventor: Anthony J. Bacchi, West Hurley, NY (US)

(21) Appl. No.: 15/066,852

(22) Filed: Mar. 10, 2016

Related U.S. Application Data
(60) Provisional application No. 62/130,997, filed on Mar. 10, 2015.

(51) Int. Cl. G06F 19/00

(52) U.S. Cl. CPC G06F 19/3418; G06F 19/322; G06F 19/3487

(57) ABSTRACT

A restorative healthcare monitoring, care, and management system and method is described. Telemetry and telemedicine components collect real-time patient data, along with other sources such as healthcare providers, facilities. Data is aggregated in a data repository where it can be holistically processed and utilized to populate data forms and exchange, outcome data, and urgent intervention. Sensors integrated into the system may provide broader collection abilities to enable healthcare providers to provide directed care and improve patient outcomes.

### PRIORITY CLAIM

This application claims priority to U.S. Patent Application No. 62/130,997, filed Mar. 10, 2015, and titled, “SYSTEM AND METHOD FOR PROVIDING RESTORATIVE CARE,” the contents of which is incorporated by reference in its entirety.

### BACKGROUND

Many attempts have been made to advance the delivery of healthcare across the country, with the goal of reducing cost and improving quality and population health. State government agencies such as the Medicaid Redesign Team and the Center for Medicaid and Medicare services (CMS), have recognized that unnecessary hospital readmissions can be a strain on health resources. As healthcare systems move from fee-for-service to value-based and care-management models, avoiding unnecessary hospitalizations can be a key component in healthcare transformation.

Current national and state policy has been to financially reward or penalize hospitals on the basis of their readmission history, but many readmissions can be avoided by thoughtfully enhancing the transitional care environment for those patients with multiple comorbidities that result in rehospitalizations. Especially in rural communities across New York State, where health resources are significantly scarcer, enhancing transitional care facilities is imperative to successfully reduce readmissions.

It has been found that by integrating advanced monitoring and management apparatus into such a care model, that patient care is greatly enhanced, with reduced readmission and reduced cost.

Developing such a transitional care environment readily aligns with the goals and objectives of the Affordable Care Act, the New York State Delivery System Reform Incentive Payment (DSRIP) program, and the New York State Innovation Model grant from CMMI. This new care model will offer numerous benefits, including fewer patients and families experiencing the emotional turmoil and physically draining reality of being “in and out” of the hospital. In addition, there are considerable gains to be experienced by hospitals—one of our health care system's most valuable resources—by investing in the enrichment of a care continuum and the associated reduction of admission rates. Finally, this model will alleviate stress on the system as a whole, bolstering a more integrated care delivery model that facilitates patients' access to acute services and an enhanced clinical workforce to meet the wide spectrum of care needs.

### BRIEF DESCRIPTION OF THE DRAWINGS

The features and advantages of the present disclosure will be more fully understood with reference to the following detailed description when taken in conjunction with the accompanying figures, wherein:

FIG. 1 is a functional block diagram of a data collection component of an embodiment of the present invention.

FIG. 2 is a flowchart showing an exemplary system flow involving a multi-channel electrocardiogram (EKG) monitor.

### SUMMARY

In some embodiments, a healthcare monitoring system may include a server computing device implementing a data repository for aggregating secure patient data and/or a group of patient data inputs in communication with the data repository a secure portal for accessing patient data.

In some embodiments, the secure portal is configured to generate structured datasets based pre-determined templates. In some embodiments, the system is configured to provide an intervention alert when a predetermined criterion in the patient data is met. In some embodiments, at least one of the patient data inputs is a multi-channel physiological monitor in communication with the data repository and configured to provide real-time patient data. In some embodiments, the patient data may include, at least one of: blood pressure, pulse, pulse oximetry, cardiac output, cardiac index, systemic vascular resistance, stroke volume, and/or cardiac rhythm. In some embodiments, at least one of the pre-determined templates is the Outcome and Assessment Information Set template.

In some embodiments, such a healthcare monitoring system may further include a dedicated patient facility in which patients are monitored using multi-channel physiological monitoring devices. In some embodiments, such a healthcare monitoring system may further include a restorative care unit for collecting patent data and providing patient care.

In some embodiments, a method for providing optimized healthcare may include providing a patient data repository configured to receive patient data from a group of remote sensors, providing a secure portal for accessing the data, analyzing data in the repository in real time using the secure portal to determine if a predetermined threshold has been exceeded, and/or providing an intervention alert if the predetermined threshold has been exceeded.

In some embodiments, a healthcare monitoring system may include means for storing patient healthcare data, means for collecting physiological data on one or more patients and transmitting to the means for storing patient healthcare data, means for accessing the patient healthcare data, means for analyzing the patient healthcare data, and/or means for generating an intervention alert if a predetermined patient data threshold has been exceeded.

### DETAILED DESCRIPTION

In embodiments, a restorative care and monitoring system is described. Consistent with industry trends, residents admitted to a facility utilizing the present invention may arrive with greater medical complexity and require a more comprehensive level of care. To appropriately care for this higher acuity patient population, an improved delivery system is described in which clinical services delivery may be modified by adjusting the level of clinical staffing, and through more effective physician and nursing oversight. In an exemplary embodiment, a participating facility may utilize a fully-credentialed multispecialty medical staff that incorporates the use of modern technology, such as, telemetry and telemedicine, and in particular an integrated monitoring system that is less physically invasive to patients and provides a broader dataset. To complement the medical staff, a professional nursing staff may be utilized with ICU/CCU training, as well as respiratory therapists, occupational and speech therapists, pharmacists, registered dietitians, social workers, discharge planners and others to address the needs of these medically complex patients.

In embodiments, an exemplary unit may consist of a number of beds in a dedicated area of a healthcare facility. While the number of beds will depend on resources available and patient load, a test embodiment utilized was constructed with 18 patient beds. Patient beds may change depending on the needs of the environment, and may be specialized for particular medical conditions (e.g., specialized cardiac beds), or may be adjustable to meet a range of patient needs.

In embodiments, a data repository may be used to aggregate patent data from a variety of input sources to provide healthcare providers with a holistic overview of the patient's condition and enable an appropriate response.

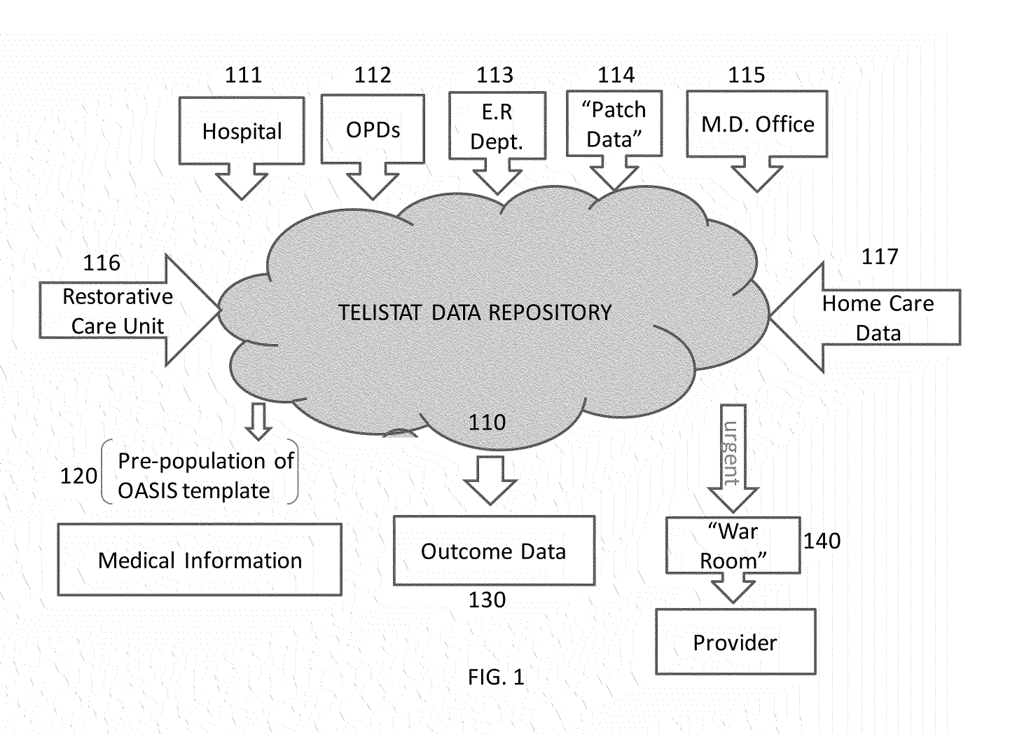

Referring to FIG. 1, a functional block diagram of such a system is shown. Data repository 110 may be any centralized electronic storage medium that permits remote access. In embodiments, data repository 110 may be any commercially available cloud storage service that provides mass storage of data and is accessible through custom software, a web interface, an application programming interface (API), or similar. In a preferred embodiment, data repository 110 is encrypted and the system is fully compliant with the Health Insurance Portability and Accountability Act (HIPAA).

A variety of data input points may be connected to data repository 110, aggregating information on multiple patients from multiple sources. For example, inputs may include patient information from traditional hospitals 111, hospital out-patient departments 112, hospital emergency rooms 113, cardiac event monitoring systems 114, and traditional doctor's offices. In addition, data may come from the restorative care unit 116 described herein, along with data from home care administration 117.

Data received through these various sources can be varied and may include demographic data, admitting diagnoses, comorbidities, medications taken, allergies, advance directives from providers, and current diagnoses, among many others.

Real time patient monitoring may be incorporated into the system. Depending on the sensors utilized, various physiological data points may be continuously monitored including, blood pressure, pulse, pulse oximetry, cardiac output, cardiac index, systemic vascular resistance, stroke volume, cardiac rhythm, and st elevation/depression, among others. Additionally, weight, activity, hydration, diabetes, CO2 retention, pulmonary function, sleep study data, body posture, and fall detection may also be monitored.

With a holistic dataset, a variety of healthcare management tasks may be undertaken. Referring to FIG. 1, data from data repository (and inputs 111-117) may be used to pre-populate the Outcome and Assessment Information Set (OASIS) template 120 that is used by the federal government and agencies, state governments and agencies, home health agencies, software vendors, professional associations and others to ensure standards in care. OSAIS data collection includes information on the health of a home care patient, and is the basis for monitoring improvement and outcome, and is also required in most instances by the federal government for providers of services under Medicare. While an important tool in monitoring patient outcomes, it has been recognized that the OASIS data collection tool can be cumbersome and prone to error in data entry. By providing for auto-completion of an OASIS template from disparate sources of patient data, these burdens on the healthcare provider are alleviated, leading to better patient outcomes.

Apart from the OASIS system, outcome data 130 may be generated to report on individual patient outcomes, or trends in patient care. Where the dataset indicates an urgent patient healthcare situation, a virtual patient war room 140 may be organized to focus resources (e.g., medication, specialists, etc.) on the particular situation. Intervention alerts may be used to warn of incipient predictable conditions such as congestive heart failure, coronary artery disease, chronic obstructive pulmonary disease, diabetes, dehydration, sleep apnea, sepsis, falls, and failure to comply with medication prescriptions, among others.

In embodiments, residents admitted to the unit may be outfitted with a portable telemetry device that registers real-time physiological data such as, for example, cardiac rhythms. Rhythms may be transmitted from the telemetry unit to the central nursing station where nurses can monitor for abnormal rhythms. In embodiments, redundancy for rhythm monitoring may be performed by an off-site location where specially-trained telemetry personnel can monitor for real time abnormal changes in cardiac rhythm. Abnormal rhythm changes are immediately identified and called into specifically identifiable personnel within the unit. Such a configuration allows for immediate medical intervention by both physician and nursing staff to prevent decompensation of the resident, thereby preventing a possible readmission to the hospital.

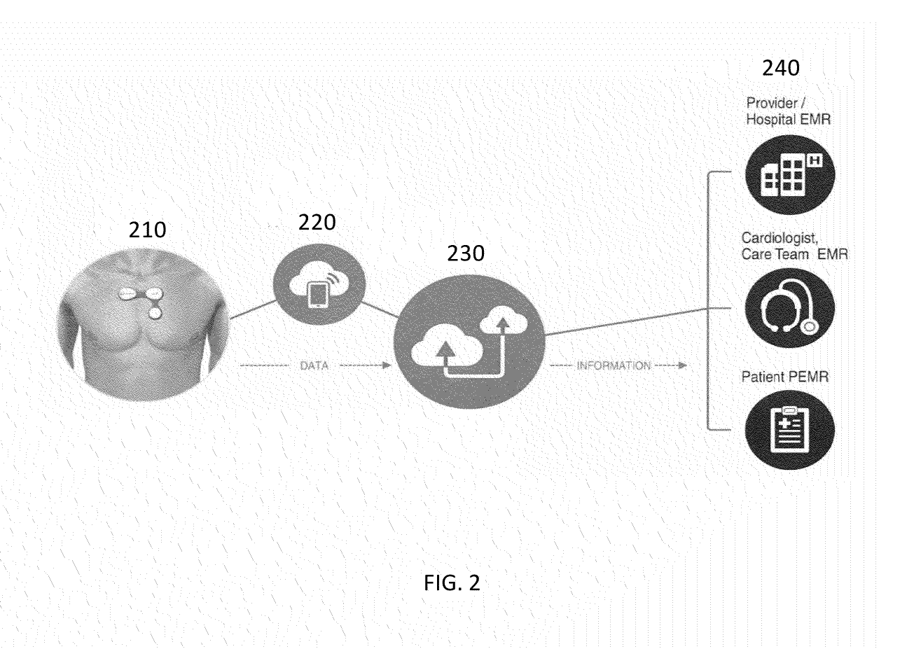

In an embodiment, an EKG monitoring apparatus was utilized, allowing for immediate transmission of a 12-lead EKG with interpretation directly to a physician in any location. Referring to FIG. 2, an exemplary EKG monitoring patch for use with the present invention is shown. A wireless remote telemonitoring patch 210 is shown with up to 12 leads, and ability to monitor heart rate, heart rhythm, and other vital signs. Patch 210 may be in communication with mobile gateway such as a localized portable computing device 220 such as a smartphone or tablet. A data repository 230 (as described above) is also provided for receiving EKG data from patch 210, either directly or via portable computing device 220. Patient data may then be passed along to healthcare providers and analysts 240 to determine if intervention is warranted.

In addition to monitoring hardware, professionally-trained nurses are utilized, particularly those with either an ICU or CCU background and who are certified in basic and/or advanced cardiac life support (BCLS/ACLS), intravenous IV insertion and telemetry experience. In exemplary embodiments, nurses may be assigned to a 1:6 resident staffing ratio with additional support coming from two certified nursing assistants (CAN).

In embodiments, telemedicine apparatus may be to allow patients to have consultations with a variety of specialty physicians who can in turn consult with the resident's primary care provider to more effectively coordinate care leading to better outcomes and decreased length of stays. Telemedicine technology has been proven extremely effective in limiting hospital readmissions in other states—including in Massachusetts where Harvard Medical researchers quantified this claim.

Each unit may also have an RN Care Manager who acts as a resident advocate and helps to monitor the residents' health needs, provides resident education, protects confidentiality issues, and coordinates community resources. The goal is to enhance communication with the interdisciplinary healthcare team members and the resident's family thus reducing or eliminating fragmentation or gaps in treatment plans while keeping the resident's family fully informed. The unit may have physician coverage for a predetermined minimum number of hours each day, with a nurse practitioner covering throughout the night.

Oversight of the unit may be provided by the facility's chief medical officer and medical director, who are committed to implementing the NYS Medical Direction guidelines to ensure exemplary physician services.

In embodiments, a home residency program may be provided to elevate the restorative process to the next level, extending the continuum of care to the resident's home with consistent caregivers, sharing pertinent healthcare information from the restorative care unit to the home care coordination team. The team consists of the RN care manager from the TRCU, the discharge planner from the TRCU, as well as the RN Case Manager and field nurse from the home care division. The coordination team clearly identifies the individual care plan needs of the resident prior to returning home. This care delivery model bridges the gap from post-discharge to home by individualizing each residents' care plan prior to the discharge, with previous caregivers who are familiar with the residents' recent medical history.

While most residents that are discharged from a sub-acute unit are able to return home, more than half will require some form of home care therapy within the first 90 days.

To facilitate the transition, the RN field nurse who performs the initial home assessment may arrive within 24 hours of the residents return home, armed with a comprehensive care management plan and a prepopulated OASIS assessment form, thereby eliminating the need for redundant data entry. In exemplary embodiments, the geographic catchment area was as been deliberately limited to a 30-mile radius allowing the nurse more face to face time with the resident, as opposed to spending needless travel time.

Nurses operating in this configuration may be equipped with various technology to provide daily monitoring of the resident's vital signs such as monitoring blood pressure, pulse, temperature, weight and medications, even when the nurse is not present. This monitoring provides assistance in regulating certain diseases and allows for expedient intervention at the first sign of physical decompensation.

If there are changes in the patient's vital signs, the field nurse may return with a portable telemedicine unit to perform an immediate medical assessment of the resident's condition. Through the use of the telemedicine unit, the nurse can communicate directly with the resident's primary care provider, nurse practitioner, and RN case manager to coordinate a treatment and follow-up plan. This consultation may allow for improved outcomes, earlier intervention and significant reduction in hospital readmissions.

In embodiments, a family support program may be provided. A dedicated 24-hour RN hotline will allow to contact expert nursing help and advice, and receive specific disease education and treatment goals and expectations, such that families and care givers are comfortable and confident in the care they provide to the resident.

The foregoing restorative care system reduces readmissions by improving the care environment, especially in rural or underserved areas, and represents a key initiative in seeking to neutralize the many disadvantages rural communities face in the delivery of healthcare. This evidence-based approach provides timely and focused interventions to residents experiencing acute clinical changes in condition, re-hospitalization rates will be reduced while improving quality of life and individual functional status.

It will be understood that there are numerous modifications of the illustrated embodiments described above which will be readily apparent to one skilled in the art, including combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A healthcare monitoring system comprising:
a server computing device implementing a data repository for aggregating secure patient data;
a plurality of patient data inputs in communication with said data repository
a secure portal for accessing patient data, wherein said secure portal is configured to generate structured datasets based pre-determined templates; and
wherein said system is configured to provide an intervention alert when a predetermined criterion in the patient data is met.

2. The healthcare monitoring system of claim 1 wherein at least one of said patient data inputs is a multi-channel physiological monitor in communication with said data repository and configured to provide real-time patient data.

3. The healthcare monitoring system of claim 1 wherein said patient data includes at least one of: blood pressure, pulse, pulse oximetry, cardiac output, cardiac index, systemic vascular resistance, stroke volume, and cardiac rhythm.

4. The healthcare monitoring system of claim 1 wherein at least one of said pre-determined templates is the Outcome and Assessment Information Set template.

5. The healthcare monitoring system of claim 1 further comprising a dedicated patient facility in which patients are monitored using multi-channel physiological monitoring devices.

6. The healthcare monitoring system of claim 1 further comprising a restorative care unit for collecting patent data and providing patient care.

7. A method for providing optimized healthcare comprising:
providing a patient data repository configured to receive patient data from a plurality of remote sensors, wherein said plurality of remote sensors include at least one multi-channel sensor configured to provide real time physiological patent data;
providing a secure portal for accessing said data;
analyzing data in said repository in real time using said secure portal to determine if a predetermined threshold has been exceeded;
providing an intervention alert if said predetermined threshold has been exceeded.

8. The method of claim 7 wherein said data includes at least one of: blood pressure, pulse, pulse oximetry, cardiac output, cardiac index, systemic vascular resistance, stroke volume, and cardiac rhythm.

9. The method of claim 7 further comprising the step of providing mobile application software configure to access patient data in said data repository.

10. The method of claim 7 further comprising the step of utilizing said secure portal to pre-populate a patient care reporting form.

11. The method of claim 7 further comprising the step of organizing a utilizing said secure portal to pre-populate a patient care reporting form.

12. A healthcare monitoring system comprising:
means for storing patient healthcare data;
means for collecting physiological data on one or more patients and transmitting to said means for storing patient healthcare data;
means for accessing said patient healthcare data;
means for analyzing said patient healthcare data; and
means for generating an intervention alert if a predetermined patient data threshold has been exceeded.
